(19) United States
(12) Patent Application Publication
(10) Pub. No.: US 2003/0012424 A1
(43) Pub. Date: Jan. 16, 2003

(54) Modelling of three dimensional shapes

(75) Inventors: Ruggero Elia Hendrik Franich, Abingdon (GB); Stefanus Johannes Petrus Westen, Didcot (GB)

Correspondence Address: LAHIVE & COCKFIELD, 28 STATE STREET, BOSTON, MA, 02109, US

(73) Assignee: D Vision Works Limited, Abingdon (GB)

(21) Appl. No.: 10/193,819

(22) Filed: Jul. 12, 2002

(30) Foreign Application Priority Data
Jul. 12, 2001 (GB) 0117126.3

(51) Int. Cl. G06K 9/00

(52) U.S. Cl. 382/154

(57) ABSTRACT

A method of digitally modelling a three dimensional shape comprises the steps of acquiring a plurality of images of the object including images in different orientations, identifying sections of the object, for each section masking the images so as to exclude other sections and deriving a digital representation of the shape of that section from the silhouette thereof, and joining the digital representations of the sections to form a digital representation of the three dimensional shape. It is naturally preferable for the sections to be line-convex, but it may be useful to compromise and select sections that are only nearly so. In this way, a number of 3D representations are prepared and stitched together to form a whole. The method can be implemented on a computer.

### FIELD OF THE INVENTION

The present invention relates to a process for the modelling of three dimensional shapes, and apparatus adapted to model three dimensional shapes.

### BACKGROUND ART

It is routinely necessary to create a digital model of an existing three-dimensional article. In this process, a computer-readable map of the outline of the article is constructed from a number of photographs. The map can then be manipulated (if desired) to show the article from an intermediate viewpoint that does not correspond to any of the viewpoints originally used. The quality of this derived image will depend on the quality of the map that is created.

An established means of reconstructing the shape is known as “shape from silhouette”. This is a robust technique which requires several images of an object taken from different camera standpoints. For each of these images, the position (relative to the object) of the camera that recorded the image is determined, and the silhouette of the object against the background that it obscures is determined.

The position of the camera is usually determined by having some features of known geometric position in the image, so that the camera position can be accurately determined once those features have been picked out. For example, three or more fixed references can be placed around the object.

One common way of picking out the silhouette of the object is by blue screening, in which the object is placed in front of a uniformly coloured background (usually blue or green) so that the object can be automatically separated from its background.

Given the camera positions and silhouettes it is possible to determine an approximation of the 3-D shape of the object. The shape is approximated by the set of points in space which fall inside the silhouette in all images. This process is illustrated schematically in FIG. 1. An object 4, in this case a sphere, is modelled from three camera views, 1, 2 and 3. FIG. 2 shows the reconstruction 5 of the shape of object 4 that can be made from the three camera positions 1, 2 and 3. It can be seen that the reconstruction includes inaccuracies such as at 6, due to the relatively small number of camera positions. More images would give a better quality shape reconstruction.

Another fundamental limitation of the shape from silhouette process is that the use of a silhouette limits the techniques to line-convex shapes. Concave areas will not be revealed in silhouette and will thus appear in the reconstruction to be “closed in” by a solid cover. In general, shape from silhouette approximates an object by its line-convex hull. Although the line-convex hull is very similar to the actual object shape for simple shapes (such as a box or ball), for more complex shapes (such as the human head or human body) this difference can be quite large. In these circumstances, the shape from silhouette method does not approximate to the shape well enough for many applications.

A good example of this is the nose on a human face which will give a poor approximation of the head shape, as illustrated schematically in FIGS. 3a and 3b. The best approximation that a shape from silhouette method will ever be able to make of the head shape 7 is the reconstruction 8, in which the concave areas 9, 10 either side of the nose 11 are smoothed over at 12 and 13. This is one of the fundamental limitations of the shape from silhouette technique that the present invention addresses.

### SUMMARY OF THE INVENTION

The present invention therefore provides a method of digitally modelling a three dimensional shape, comprising the steps of acquiring a plurality of images of the object including images in different orientations, identifying sections of the object, for each section masking the images so as to exclude other sections and deriving a digital representation of the shape of that section from the silhouette thereof, and joining the digital representations of the sections to form a digital representation of the three dimensional shape.

It is naturally preferable for the sections to be line-convex. However, it may be possible to improve on existing techniques using sections that are nearly so or approximations thereto. As a smaller number of sections will reduce processing load, this may be a more acceptable compromise.

### BRIEF DESCRIPTION OF THE DRAWINGS

An embodiment of the present invention will now be described, with reference to the accompanying figures, in which;

FIGS. 1 and 2 show the modelling of an object by a known shape from silhouette method;

FIGS. 3a and 3b illustrate a limitation of this technique in dealing with concave objects;

FIG. 4 illustrates the method of the present invention; and

FIGS. 5a to 5j show the technique applied to a human head.

### DETAILED DESCRIPTION OF THE EMBODIMENT

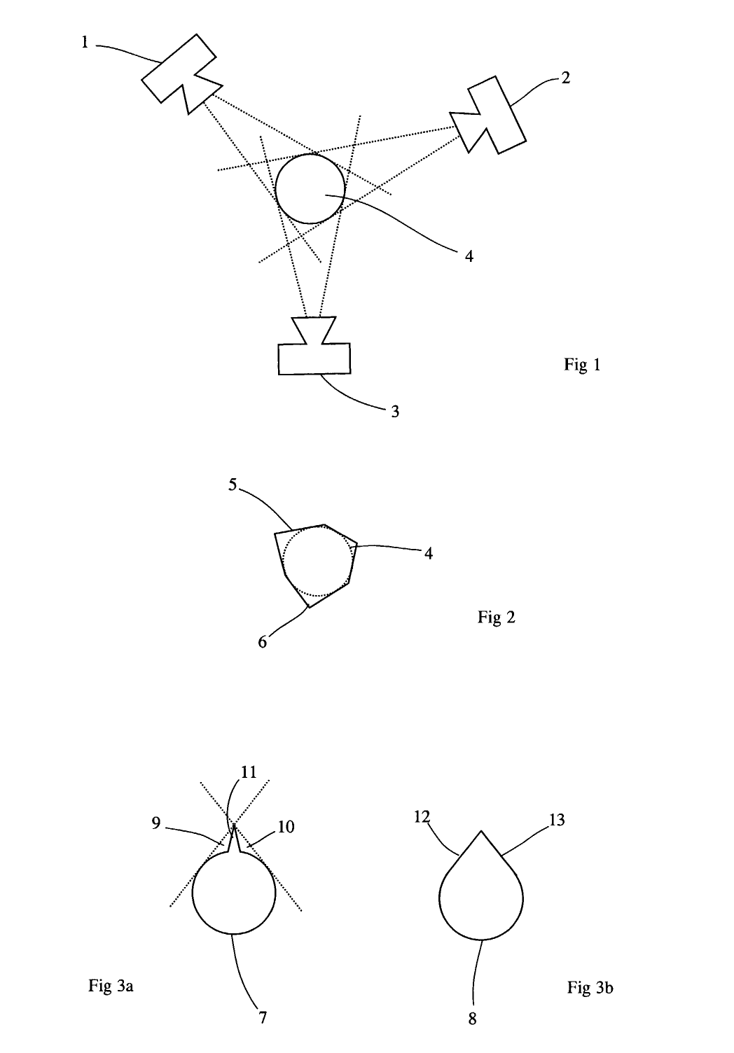

FIGS. 1, 2, 3a and 3b are described above and will not be described further.

FIG. 4 illustrates the present invention, applied by way of example to a schematic head 20 identical to that of FIG. 3a. This consists of a main part 22 and a nose part 24. In a first step of the invention, the object is divided into two sections corresponding to these parts. A greater number of sections could be employed if needed, depending on the object concerned. One section corresponds to the main part 22 whilst the other corresponds to the nose part 24. Computation then proceeds in parallel on duplicated sets of images, each set of which has all but one section masked off.

In this case, a first computation proceeds on a first masked set of data 26 representing the main part 22 with the nose part 24 masked off. A second computation proceeds on a second masked set of data 28 representing the nose part 24 with the main part 22 masked off. These lead, respectively, to a model 30 of the main part 22 and a model 32 of the nose part 24. These two models are then stitched together as described below to form a complete model 34 of the head 20.

It has been mentioned that computation proceeds in parallel. By this is meant that the computation of the models of the individual parts proceeds separately. This may be done by way of parallel processing if desired but this is not essential. However, the technique lends itself well to parallel processing.

The division of the object into sections can be done manually, by (for example) an operator highlighting areas of the images and outlining them. Outline algorithms are also known which trace the outline of an object in an image and these can assist an operator. An operator could choose sections and then define them by tracing around that section on each image using a pointing device such as a mouse, light pen, tablet or the like. If an outlining algorithm is available, the operator could select a point within the intended section using a pointing device and allow the software to trace that section automatically and propose an outline. Division could also be carried out automatically by software which examines the interior of images (ie not just the silhouette).

Thus, according to this invention, given a set of n photographs:

F={fᵢ,i=1 . . . n},

and a set of n camera positions (one for each photograph)

C={cᵢ,i=1 . . . n}

we define a set of masks:

M={m_{i,j},i=1 . . . n, j=1 . . . m}.

where m is the number of masks per photograph.

Each mask contains an array of binary values, one for each pixel in the photograph. The masks combined with the camera positions define a set of m convex hulls hⱼ:

H={hⱼ,=1 . . . m),

where hⱼ is given by:

hⱼ(x,y,z)=M_{1,,j}(x₁,y₁)ˆ M_{2,,j}(x₂,y₂)ˆ . . . ˆ M_{n,,j}(x_{n,}yₙ),

where (x₁,y₁) is the projection of the point (x,y,z) in photograph i.

The set of convex hulls H is subdivided into two subsets, a set of positive convex hulls:

Hₚ={h_{p,j,}j=1 . . . nₚ},

and a set of negative convex hulls

Hₙ={h_{n,j,}j=1 . . . nₙ}.

The 3-D reconstruction is given by the set of points P which are contained in one or more of the positive convex hulls and none of the negative hulls:

P={p|(p∈h_{p,1}Vp∈h_{p,2}V . . . Vp∈h_{p,np})ˆ p∉h_{n,1}ˆ p∉h_{n,2}ˆ . . . ˆ p∉h_{n,nn}}

In conventional shape from silhouette, m=1 and Hₙ is empty thus limiting the reconstructed shape to a single line-convex hull. Using the invention described here it is possible to model much more intricately shaped objects that cannot be modelled effectively using conventional shape from silhouette. In addition, convex shapes that could be modelled with shape from silhouette can now often be modelled with fewer photographs, taken from less awkward viewpoints.

Images can be derived from a variety of sources. Existing photographs can be scanned to produce digital images for processing. A digital camera can provide digital images directly. A digital or analogue video camera could provide a series of frames which can be converted to individual images for processing. For example, a video or still camera could be mounted on a track or robotic arm or the like and rotated around the object concerned to yield a series of images from different viewpoints. In a fully automated system, the camera could be linked permanently to the computer and be moved under the control of software, in which case the viewpoint would be known to the computer ab initio removing the need for reference markers in the image. Alternatively, the camera could be moved manually but with its position monitored by the arm on which it is held. Such arms are known, and comprise a number of links whose angle is measured by potentiometers or the like. As a result, the position of the end of the arm can be determined by calculation based on the (fixed) position of the base, the known lengths of each link, and the measured angles.

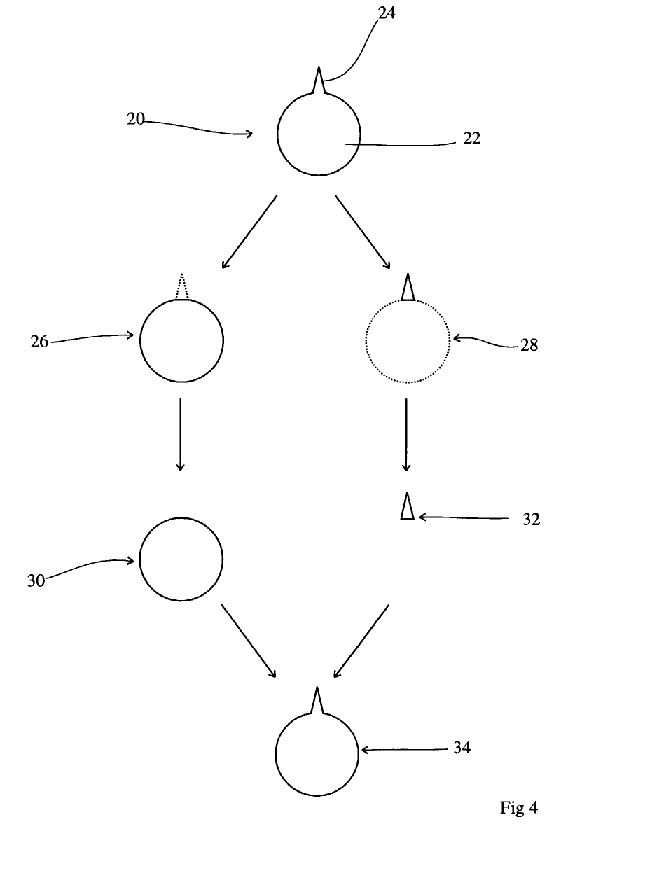

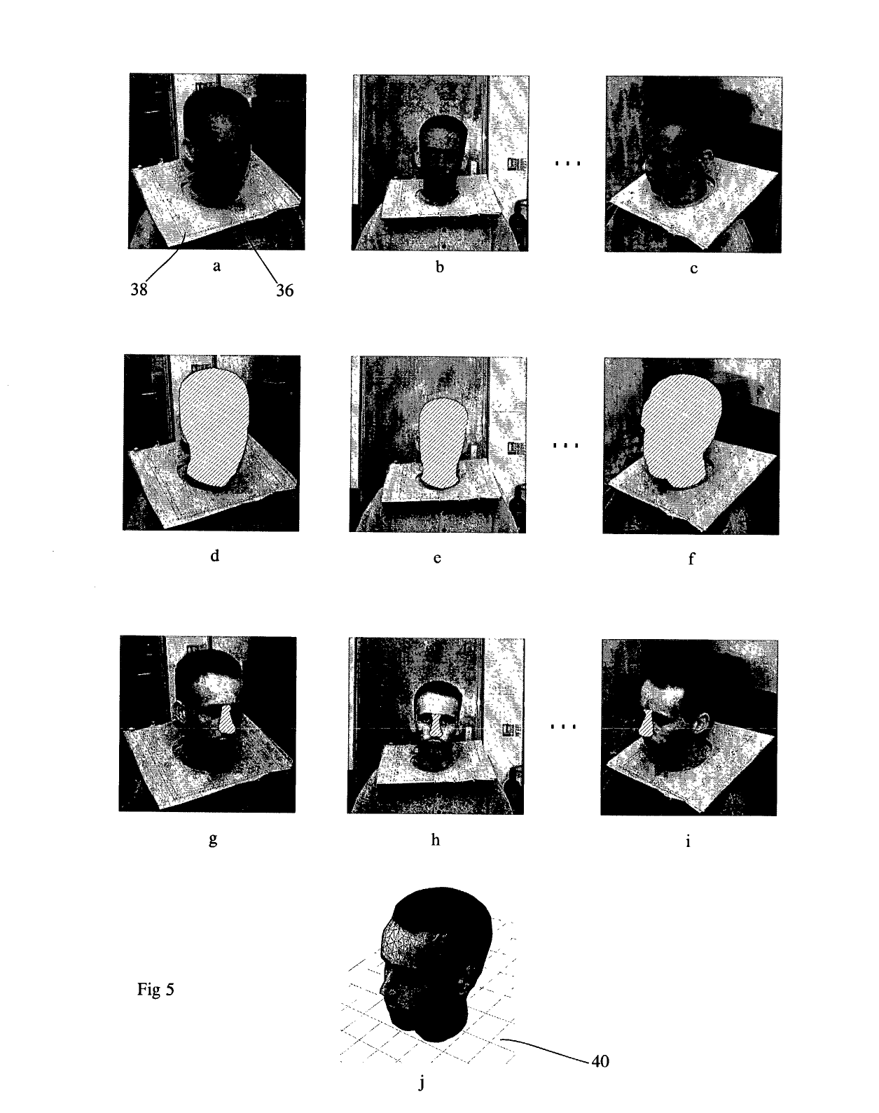

FIGS. 5a to 5j show the method applied to a real human head. FIGS. 5a, 5b and 5c are three of the views that are taken with a digital camera from each of a range of views. The person whose head is to be modelled has a reference plate 36 around their neck, on which is marked a number of reference points 38. This remains stationary during the process and provide a fixed frame of reference for the software to derive the location and angle from which each image is taken. As indicated, more than three images are prepared and FIGS. 5a, 5b and 5c are representative only.

FIGS. 5d, 5e and 5f show the processing of the images of FIGS. 5a, 5b and 5c respectively to remove nose detail and derive the silhouette of the main part only of the head. Likewise, FIGS. 5g, 5h and 5i show the processing of the images of FIGS. 5a, 5b and 5c respectively to leave only nose detail and derive the silhouette thereof. In the images shown in FIGS. 5d to 5i, the mask is shown by obscuring the part of the image which is included in the relevant section.

These two sets of silhouettes are then analysed according to known shape from silhouette methods by a suitably programmed personal computer to derive a pair of three dimensional representations. These are then joined to produce the representation shown in FIG. 5j, of the complete head with nose. A base plane 40 can be seen in FIG. 5j which corresponds to the reference plate 36.

It will thus be seen that the present invention offers a method which can be embodied in software to provide an efficient means of deriving more complex three dimensional shapes from two dimensional images.

1. A method of digitally modelling a three dimensional shape, comprising the steps of acquiring a plurality of images of the object including images in different orientations, identifying sections of the object, for each section masking the images so as to exclude other sections and deriving a digital representation of the shape of that section from the silhouette thereof, and joining the digital representations of the sections to form a digital representation of the three dimensional shape.

2. A method according to claim 1 in which the sections are line-convex.

3. A method according to claim 1 in which the images are masked so as to include the section concerned and exclude all other sections.

4. A method according to claim 1 in which sections of the images are identified by the user.

5. A method according to claim 1 which joins the representations of the sections by preparing a set of positive hulls all of which include only points falling within the three dimensional shape.

6. A method according to claim 5 in which the representations of the sections are joined by establishing points which fall within any of the positive hulls.

7. A method according to claim 1 which joins the representations of the sections by preparing a set of negative hulls all of which include only points falling outside the three dimensional shape.

8. A method according to claim 7 in which the representations of the sections are joined by establishing points which fall outside all negative hulls.

9. Apparatus for digitally modeling a three dimensional shape comprising an image capture means, and an image analysis means,
the image capture means being arranged to acquire a plurality of images of the object including images in different orientations, the image analysis means being arranged to identify sections of the object, for each section mask the images so as to exclude other sections and deriving a digital representation of the shape of that section from the silhouette thereof, and join the digital representations of the sections to form a digital representation of the three dimensional shape.

10. Apparatus according to claim 9 in which the sections are line-convex.

11. Apparatus according to claim 9 in which the images are masked so as to include the section concerned and exclude all other sections.

12. Apparatus according to claim 9 including a user input device, in which the image analysis means is arranged to receive input from the user input device identifying sections of the images.

13. Apparatus according to claim 9 in which the image analysis means joins the representations of the sections by preparing a set of positive hulls all of which include only points falling within the three dimensional shape.

14. Apparatus according to claim 13 in which the representations of the sections are joined by establishing points which fall within any of the positive hulls.

15. Apparatus according to claim 9 in which the image analysis means joins the representations of the sections by preparing a set of negative hulls all of which include only points falling outside the three dimensional shape.

16. Apparatus according to claim 7 in which the representations of the sections are joined by establishing points which fall outside all negative hulls.

17. Apparatus according to claim 9 in which the image analysis means is a programmed computer.

18. Apparatus according to claim 9 in which the image capture means is a digital camera.

19. Apparatus according to claim 9 in which the image analysis means is a programmed computer and the image capture means is a digital camera, the computer and camera being permanently linked.
